(19) United States
(12) Patent Application Publication
(10) Pub. No.: US 2012/0001507 A1
(43) Pub. Date: Jan. 5, 2012

(54) SYSTEM AND METHOD FOR ACTIVELY CONTROLLING THE THRUST ACTING ON A ROTOR

(75) Inventor: Kristan Brice Sears, Schenectady, NY (US)

(73) Assignee: General Electric Company

(21) Appl. No.: 12/828,586

(22) Filed: Jul. 1, 2010

(51) Int. Cl. H02K 7/09

(52) U.S. Cl. 310/90.5

(57) ABSTRACT

Embodiments of the present invention provide a method and system of actively controlling, in real-time, a thrust load experienced by a rotor. The rotor may have the form of a single or multi-part shaft, upon which rotatable components are mounted. Embodiments of the present invention incorporate electromagnets, which may be in the form of an electromagnetic device located adjacent a thrust piston on the rotor, or other embossed feature. A control system may modulate the electrical current through the electromagnetic device to control the thrust load and the axial movement of the rotor. This may create a balance thrust or zero thrust condition, if desired. Alternatively, modulating the electrical current may allow biasing the thrust load in a desired direction.

### BACKGROUND OF THE INVENTION

The present invention relates generally to the operation of a turbomachine, and more particularly, to a system for actively reducing the axial thrust load acting on a rotor of a turbomachine.

Turbomachines, such as steam turbines, gas turbines, and the like, operate in a wide variety of applications, including, but not limited to, power generation and propulsion. As the turbomachine operates, the turbomachine rotor can experience high levels of axial thrust (hereinafter “thrust”, “thrust load”, or the like). A known solution for transferring the thrust load from rotating to stationary components employs thrust bearings, which absorb the thrust load without interfering with the rotation of the rotor and associated components. The level of thrust experienced by thrust bearings generally varies. Differences in rotor manufacture, and changes in flow path pressure, can produce large fluctuations in the thrust load. Some turbomachines employ large thrust bearings to reduce these large fluctuations. Large thrust bearings require substantial amounts of fluid and experience large friction losses; which may cause excessive power losses and reduce the overall efficiency of the turbomachine.

One solution for addressing those issues uses a pressurized fluid, which provides an opposing thrust force. Here, the fluid is pumped into the bearing housing to act as a lubricant between the rotating components of the thrust bearing and the stationary components of the bearing housing. However, this solution decreases the overall efficiency of the turbomachine, because of the viscous losses of the lubricating fluid. Another solution incorporates electromagnet systems to achieve a constant thrust load. However, this solution does not actively change the thrust load based on the current operational need.

Therefore, there is a desire for an improved system for controlling the thrust load experienced by a turbomachine. The system should reduce the frictional, power, and efficiency losses associated with currently known systems. The system should allow real-time control of the thrust load, as the turbomachine operates.

### BRIEF DESCRIPTION OF THE INVENTION

In accordance with an embodiment of the present invention, a system adapted for actively changing a thrust load experienced by a rotor, the system comprising: an electromagnetic device configured for reducing a thrust load currently acting on a rotor, wherein the electromagnetic device encloses a portion of the rotor and is located adjacent a thrust piston, which is integrated with the rotor; and a controller configured for operating the electromagnetic device to vary the thrust load in real-time, wherein the controller determines a current thrust load and a desired thrust load; wherein the controller energizes the electromagnetic device to generate an opposing thrust load that counteracts the current thrust load

In accordance with an alternate embodiment of the present invention, a method of actively controlling a thrust load experienced by a turbomachine, the method comprising: providing a turbomachine comprising a rotor, a plurality of rotating components connected to the rotor, and a plurality of stationary components, wherein the rotor is disposed within the plurality of stationary components; providing an electromagnetic device configured for reducing a thrust load acting on a rotor, wherein the electromagnetic device encloses a portion of the rotor and is located adjacent a thrust piston that is integrated with the rotor; determining a current thrust load, in real-time; determining a desired thrust load, in real-time; operating the electromagnetic device to generate an opposing thrust load to counteract the current thrust load; wherein the method varies the opposing thrust load as the current thrust load changes while the turbomachine operates.

### BRIEF DESCRIPTION OF THE DRAWINGS

FIG. 1 is a schematic illustrating an environment in which an embodiment of the present invention may operate.

FIG. 2 is a schematic illustrating an embodiment of an electromagnetic device, positioned adjacent a thrust bearing of FIG. 1, in accordance with an embodiment of the present invention.

FIG. 3 is a schematic illustrating an embodiment of an electromagnetic device, positioned adjacent a thrust bearing of FIG. 1, in accordance with an alternate embodiment of the present invention.

FIG. 4 is a schematic illustrating an embodiment of an electromagnetic device, positioned adjacent a thrust bearing of FIG. 1, in accordance with another alternate embodiment of the present invention.

FIG. 5 is a schematic diagram illustrating a system using an electromagnetic device to control the thrust acting on the rotor, in accordance with an alternate embodiment of the present invention.

### DETAILED DESCRIPTION OF THE INVENTION

The following detailed description of preferred embodiments refers to the accompanying drawings, which illustrate specific embodiments of the invention. Other embodiments having different structures and operations do not depart from the scope of the present invention.

Certain terminology may be used herein for the convenience of the reader only and is not to be taken as a limitation on the scope of the invention. For example, words such as “upper”, “lower”, “left”, “right”, “front”, “rear”, “top”, “bottom”, “horizontal”, “vertical”, “upstream”, “downstream”, “fore”, “aft”, and the like; merely describe the configuration shown in the Figures. Indeed, the element or elements of an embodiment of the present invention may be oriented in any direction and the terminology, therefore, should be understood as encompassing such variations unless specified otherwise.

Detailed example embodiments are disclosed herein. However, specific structural and functional details disclosed herein are merely representative for purposes of describing example embodiments. Example embodiments may, however, be embodied in many alternate forms, and should not be construed as limited to only the embodiments set forth herein.

Accordingly, while example embodiments are capable of various modifications and alternative forms, embodiments thereof are illustrated by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any, and all, combinations of one or more of the associated listed items.

The terminology used herein is for describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Embodiments of the present invention have the technical effect of actively controlling, in real-time, a thrust load experienced by a rotor. The rotor may have the form of a single or multi-part shaft, upon which rotatable components are mounted. Embodiments of the present invention seek to balance the thrust while reducing the fixed bearing losses. Embodiments of the present invention incorporate electromagnets, which may be in the form of an electromagnetic device located adjacent a thrust piston on the rotor, or other embossed feature; either of which should provide an adequate surface area for an electromagnet to apply an electromagnetic force to oppose a thrust load. A control system may modulate the electrical current through the electromagnetic device to control the thrust load and the axial movement of the rotor. This may create a balance thrust or zero thrust condition, if desired. Alternatively, modulating the electrical current may allow biasing the thrust load in a desired direction. This may reduce the large variations in the overall thrust. This may also reduce the energy and efficiency losses that may be associated with some thrust bearings.

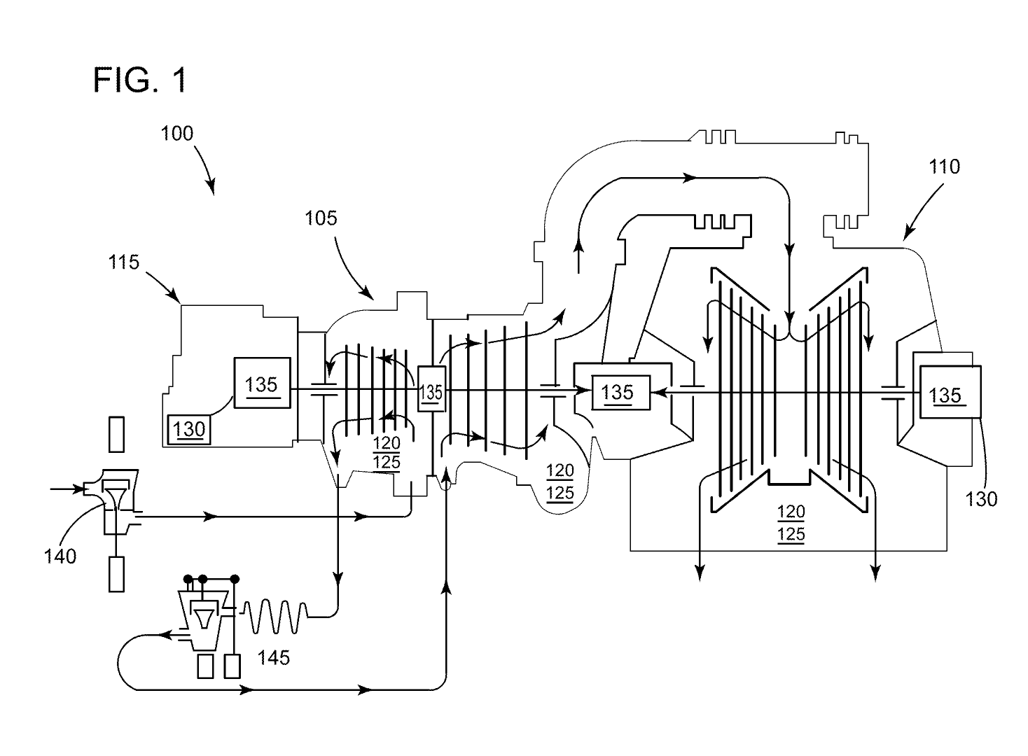

Embodiments of the present invention are described with reference to a steam turbine application. The present invention as disclosed herein, is not intended to be limited to the steam turbine application. Embodiments of the present invention may be applied to any machine having a rotor that experiences a thrust load. Referring now to the figures, where the various numbers represent like parts throughout the several views. FIG. 1 is a schematic illustrating an environment in which an embodiment of the present invention may operate. FIG. 1 illustrates an embodiment of a steam turbine 100, which includes a combined High-Pressure (HP)/Intermediate-Pressure (IP) section 105. Downstream of the HP/IP section 105 is a Low-Pressure (LP) section 110. Upstream of the HP/IP section 105 is a bearing standard, or housing 115. Rotating components 120, mounted around the rotor 130, and stationary components 125 are disposed within the sections 105,110. The rotor 130 passes through the sections 105, 110, allowing the rotating components 120 of each section 105,110 to uniformly rotate. A plurality of thrust bearings 135, which support the rotor 130, are located throughout the steam turbine 100, as illustrated in FIG. 1. Similarly, only one thrust bearing 135 may be used.

The following provides a non-limiting example of the operation of the steam turbine. FIG. 1 uses arrows to illustrate the following steam flow path. A steam admission valve 140 may be opened to allow steam, from a boiler (not illustrated), to enter the HP/IP section 105. Initially, the steam may flow upstream through the IP portion. Here, the current thrust load may be in the upstream direction. Next, the steam may exit the IP portion and enter a reheater 145. The steam may then exit the reheater 145 and reenter the HP/IP section 105, now flowing through the HP portion. Here, the current thrust load may shift to the downstream direction. Next, the steam may exit the HP portion and enter the LP section 110. Here, the steam may flow in opposing directions. After flowing through the LP section 110, the steam may exit to a condensor (not illustrated).

Embodiments of the present invention may be located adjacent at least one of the thrust bearings 135, regardless of the physical location on/or near the steam turbine 100. A user may select the location where to position an embodiment of the present invention, based on the magnitude of the thrust load experienced by a specific thrust bearing 135.

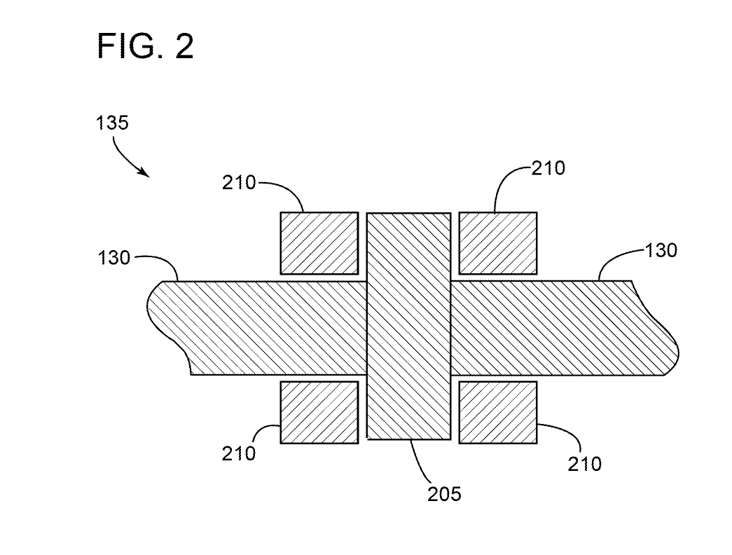

FIG. 2 is a schematic illustrating an embodiment of an electromagnetic device, positioned adjacent a thrust bearing 135 of FIG. 1, in accordance with an embodiment of the present invention. The electromagnetic device may be in the form of a cylinder 210, positioned adjacent an intermediate portion of the rotor 135, and integrated with a thrust piston 205. Here, the electromagnetic cylinder 210 may allow the ends of the rotor 130 to connect with other components, such as, but not limiting of, a generator, combustion turbine, or the like (none of which are illustrated); or other portions of the rotor 130 enclosed by a different portion of steam turbine 100. In this embodiment of the present invention, an upstream electromagnetic cylinder 210 and a downstream electromagnetic cylinder 210 may be provided with the thrust piston 205 positioned in between. This may allow control of the thrust load irrespective of the axial direction. The electromagnetic cylinder 210 may comprise an annular magnet and annular coil. When the coil is energized, a magnetic field may be generated which creates an opposing thrust load. This serves to counteract the current thrust load acting on the rotor 130. The magnetic field may comprise the form of a circular pattern along the axis of the rotor 130, and may be perpendicular to the piston.

The sizes of the electromagnetic cylinder 210 may be determined by the size of the rotor 130, associated thrust piston 205, and associated thrust bearing 135.

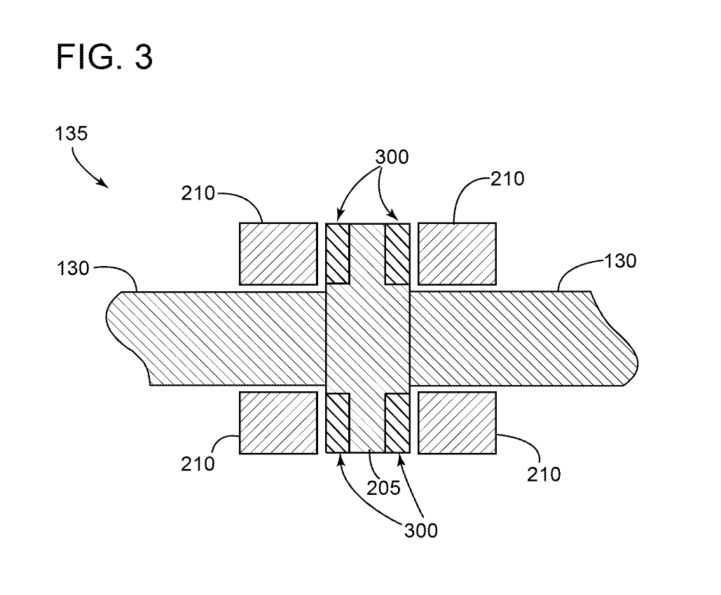

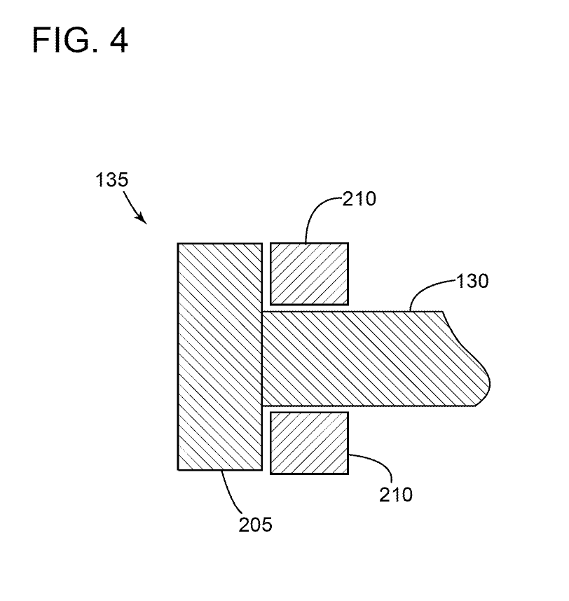

FIGS. 3 and 4 illustrate alternate embodiments of the electromagnetic cylinder 210. The discussion of each figure is therefore limited to the differences of each over FIG. 2.

FIG. 3 is a schematic illustrating an embodiment of an electromagnetic cylinder 210, positioned adjacent a thrust bearing 135 of FIG. 1, in accordance with an alternate embodiment of the present invention. Typically, the thrust piston 205 may be formed of a ferromagnetic material that receives the opposing thrust load generated by the magnetic field. However, for a thrust piston 205 that is not created of a ferromagnetic material, an alternate embodiment of the present invention may incorporate magnetic material 300. Here, the thrust piston 205 may be modified to integrate the magnetic material 300. This feature allows the electromagnetic cylinder 210 to be used on a thrust piston 205, which is not formed out of a ferromagnetic material.

FIG. 4 is a schematic illustrating an embodiment of an electromagnetic cylinder 210, positioned adjacent a thrust bearing 135 of FIG. 1, in accordance with another alternate embodiment of the present invention. Here, the electromagnetic cylinder 210 may be located adjacent the end portion of the rotor 130. In this embodiment, a single electromagnetic cylinder 210 may be used, unlike the embodiments illustrated in FIGS. 2 and 3.

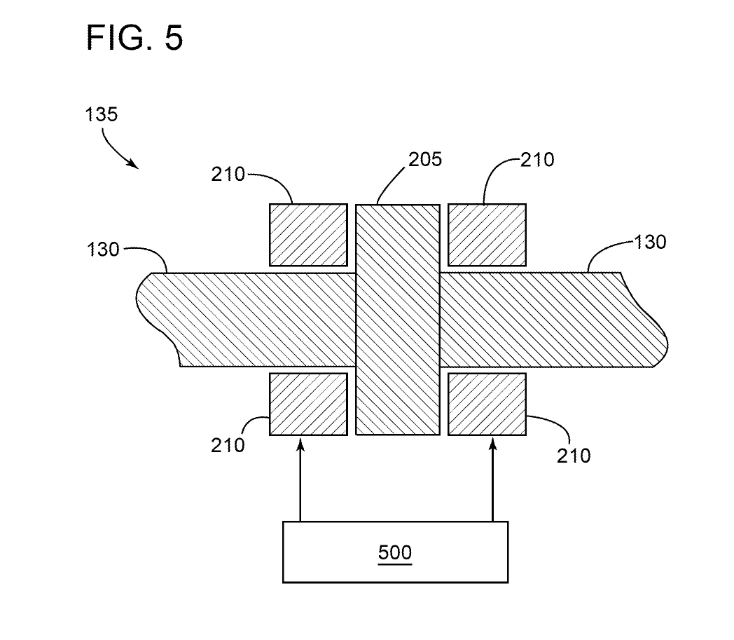

FIG. 5 is a schematic diagram illustrating a control system 500 using an electromagnetic cylinder 210 to control the thrust acting on the rotor 130, in accordance with an alternate embodiment of the present invention. FIG. 5 illustrates a control system 500 configured for actively controlling the electromagnetic cylinder 210, in real-time. The control system 500 may determine the magnitude and direction of the current thrust load, while the steam turbine 100 operates. The control system 500 may also determine the current rotor position. Next, the control system 500 may vary the electric current supplied to the electromagnetic cylinder 210. This may create the magnetic field and the opposing thrust load, as described. Next, the control system 500 may operate the electromagnetic cylinder 210 to bias the rotor 130 in a desired direction, if required. When integrated with the embodiment of FIG. 2, the control system 500 may determine whether to energize the upstream electromagnetic device, or the downstream electromagnetic device.

An embodiment of the control system 500 may perform the following steps. Determine a current thrust load, in real-time. Determine a desired thrust load, in real-time; which may be provided by an operator. Operate the electromagnetic device 210 in a manner that generates an opposing thrust load to counteract the current thrust load. The control system 500 allows may vary the opposing thrust load as the current thrust load changes while the turbomachine operates. This feature provides real-time thrust load compensation through various operating conditions. These conditions, may include, but are not limited to, start-up, loading, transient, unloading, shutdown, or the like.

Embodiments of the present invention may provide the benefit of allowing for a smaller thrust bearing. Conventionally, due to the configuration and complexity of the turbomachine, at least two thrust bearings are typically employed to absorb the thrust. If the design of the turbomachine machine requires that the thrust be biased in one direction, then an embodiment of the electromagnetic cylinder 210 may be employed to keep this thrust biased in the desired direction. Controlling the thrust in the desired direction and reducing the overall net thrust may lead to fewer or smaller thrust bearings.

As one of ordinary skill in the art will appreciate, the many varying features and configurations described above in relation to the several exemplary embodiments may be further selectively applied to form the other possible embodiments of the present invention. Those in the art will further understand that all possible iterations of the present invention are not provided or discussed in detail, even though all combinations and possible embodiments embraced by the several claims below or otherwise are intended to be part of the instant application. In addition, from the above description of several exemplary embodiments of the invention, those skilled in the art will perceive improvements, changes, and modifications. Such improvements, changes, and modifications within the skill of the art are also intended to be covered by the appended claims. Further, it should be apparent that the foregoing relates only to the described embodiments of the present application and that numerous changes and modifications may be made herein without departing from the spirit and scope of the application as defined by the following claims and the equivalents thereof.

What is claimed is:

1. A system adapted for actively changing a thrust load experienced by a rotor, the system comprising:
an electromagnetic device configured for reducing a thrust load currently acting on a rotor, wherein the electromagnetic device encloses a portion of the rotor and is located adjacent a thrust piston, which is integrated with the rotor; and
a controller configured for operating the electromagnetic device to vary the thrust load in real-time, wherein the controller determines a current thrust load and a desired thrust load;
wherein the controller energizes the electromagnetic device to generate an opposing thrust load that counteracts the current thrust load

2. The system of claim 1, wherein the electromagnetic device is positioned adjacent the thrust piston, which located adjacent an end of the rotor.

3. The system of claim 1 further comprising an upstream electromagnetic device and a downstream electromagnetic device.

4. The system of claim 3, wherein the thrust piston is positioned at an intermediate location on the rotor, and wherein the upstream electromagnetic device is positioned upstream of the intermediate location, and the downstream electromagnetic device is positioned downstream of the intermediate location.

5. The system of claim 1, wherein the rotor is a component of a steam turbine.

6. The system of claim 5, wherein the steam turbine comprises at least one section and the rotor is located within the at least one section.

7. The system of claim 6, wherein the at least one section comprises: a HP section, an IP section, or a LP section.

8. The system of claim 1, wherein the electromagnetic device generates a magnetic field along an axis of the rotor, which produces the opposing thrust force.

9. The system of claim 8, wherein the controller supplies electric current to a coil within the electromagnetic device.

10. A method of actively controlling a thrust load experienced by a turbomachine, the method comprising:
providing a turbomachine comprising a rotor, a plurality of rotating components connected to the rotor, and a plurality of stationary components, wherein the rotor is disposed within the plurality of stationary components;
providing an electromagnetic device configured for reducing a thrust load acting on a rotor, wherein the electromagnetic device encloses a portion of the rotor and is located adjacent a thrust piston that is integrated with the rotor;
determining a current thrust load, in real-time;
determining a desired thrust load, in real-time;
operating the electromagnetic device to generate an opposing thrust load to counteract the current thrust load;
wherein the method varies the opposing thrust load as the current thrust load changes while the turbomachine operates.

11. The method of claim 10, wherein the turbomachine is a steam turbine.

12. The method of claim 11, wherein the steam turbine comprises at least one section and a portion of the rotor is located within the at least one section.

13. The method of claim 10 further comprising providing an upstream electromagnetic device and a downstream electromagnetic device.

14. The method of claim 13 further comprising the step of determining whether to operate the upstream electromagnetic device, or the downstream electromagnetic device.

15. The method of claim 10 further comprising the step of operating the electromagnetic device to bias the rotor in a desired direction.

16. The method of claim 10 wherein the electromagnetic cylinder is integrated with a thrust bearing
